(19) United States
(12) Patent Application Publication
(10) Pub. No.: US 2023/0265613 A1
(43) Pub. Date: Aug. 24, 2023

(54) PROCESS FOR ACYLATION OF A HYDROXYLATED SOLID MATERIAL

(71) Applicants: CELLULOTECH INC, Victoria BC, CA (US); METIVET , Romain, Pemberton (CA)

(72) Inventor: Daniel SAMAIN, TOULOUSE (FR)

(21) Appl. No.: 18/020,353

(22) PCT Filed: Aug. 13, 2020
(86) PCT No.: PCT/EP2020/072818

§ 371 Date: Feb. 8, 2023

(51) Int. Cl. D21H 17/18; D21H 21/16; D21H 19/12; D21H 27/00

(52) U.S. Cl. CPC D21H 17/18; D21H 21/16; D21H 19/12; D21H 27/002

(57) ABSTRACT

A process for acylation of a solid material (3, 9) bearing reactogenic hydroxyls includes at least one fatty acid chloride (1) is distributed at least on the surface of the solid material (3, 9) using a distributor device (2) having an application surface. At least one fatty acid chloride (1) is distributed at least on the surface of the solid material (3, 9) is heated at a temperature, referred to as acylation temperature, below the vaporization temperature of the at least one fatty acid chloride (1), so as to enable an acylation of the solid material (3, 9). A stream of a gaseous composition (6) is directed over the said solid material (3, 9) at the acylation temperature, so as to entrain at least one portion of gaseous hydrochloric acid (7) formed by the acylation reaction

The application surface of the distributor device (2) is a velvet provided with velvet filiform elements that are suitable for taking up the at least one fatty acid chloride (1) by contact with the at least one fatty acid chloride, and releasing at least one fatty acid chloride by bringing the filiform elements of the velvet into contact with the solid material (3, 9). The distribution step (12, 14) is carried out so as to distribute over the solid material (3, 9) an amount of the at least one fatty acid chloride (1) of between 20 mg/m² and 1 g/m² surface area of the solid material (3, 9).

The invention relates to an improved process for acylation, by chromatogenic synthesis, of a solid material bearing hydroxyl groups (—OH), referred to as reactogenic hydroxyls, which are accessible and capable of reacting with a fatty acid chloride in the gaseous state. The invention therefore relates to such an improved process that makes it possible to convert such a solid material, which is hydrophilic owing to said reactogenic hydroxyls, notably owing to said surface reactogenic hydroxyls, into a hydrophobic material substantially retaining the porosity of the hydrophilic solid material. The invention relates to an improved process for acylation of such a solid material in the form of a porous or non-porous sheet—notably flat sheet. The invention relates in particular to an improved process for acylation of such a solid material in the form of a sheet of paper consisting, for the most part, of cellulose fibres, which is permeable to gases and permeable to aqueous liquids, to give a sheet of acylated paper, which is permeable to gases and has a permeability to aqueous liquids which is substantially reduced compared to the starting sheet of paper. The invention therefore relates more particularly to a process for acylation and waterproofing with respect to aqueous liquid compositions, of a sheet of paper, of a paper web or of a strip of paper. In particular, the invention relates to such an improved acylation process that makes it possible to produce an acylated paper which is permeable to air and impermeable with respect to buccal, nasal and/or ocular human liquid aqueous excretions and in particular with respect to such aqueous excretions that are carriers of pathogenic microorganisms and, in particular, carriers of infectious viral particles. More particularly, the invention relates to such a process for acylation of a paper material permeable to gases and permeable to aqueous liquids to give an acylated paper material for decontamination by filtration of a respiratory air flow. The invention also extends to such an acylated paper material capable of being obtained by a process according to the invention.

The invention relates to a process for acylation of such a solid material—notably of a flexible material capable of extending at least partly into a plane—that bears such reactogenic hydroxyls and is capable of being used on an artisanal scale, that is to say for a short-run individual preparation.

However, the invention also relates to a process for acylation of a solid material—notably of a flexible material capable of extending at least partly into a plane—that bears such reactogenic hydroxyls and is capable of being used on an industrial scale, that is to say for the acylation of a web (or strip) of solid material bearing such reactogenic hydroxyls, moving along the main axis of the web of material.

The chromatogenic acylation reaction of a solid material bearing such reactogenic hydroxyls is known, in which a long-chain fatty acid chloride in the gaseous state reacts with a surface reactogenic hydroxyl of the solid material and forms an ester group between the solid material and a hydrocarbon-based fatty chain (R) of the fatty acid chloride, according to the following equation (I):

Material—OH+R—CO—C [symbol] [symbol] Material—O—CO—R+HC [symbol] (I).

In particular, the application of the chromatogenic reaction to a cellulosic material comprising cellulose fibres bearing such reactogenic hydroxyls is known. The engagement of at least one portion of such reactogenic hydroxyls of cellulose fibres in covalent ester bonds with hydrocarbon-based fatty chains (R) makes it possible to increase the hydrophobicity of the cellulose fibres and render cellulosic materials, such as paper, which are thus acylated and are substantially impermeable to water.

The chromatogenic reaction occurs between the solid material bearing such reactogenic hydroxyls and the fatty acid chloride in the gaseous state at saturation partial pressure. It makes it possible to suspend the use of any organic solvent, the acid chloride being reactive in the gaseous state. It occurs by moderate heating of the fatty acid chloride at a temperature below its boiling point at atmospheric pressure. It also makes it possible to suspend the use of a catalyst that inevitably has to be removed at the end of the reaction. The chromatogenic reaction is moreover favoured by the fact that the gaseous hydrochloric acid (HC [symbol] ) formed is entrained by a stream of hot air applied to the solid material. This entrainment of the gaseous hydrochloric acid makes it possible to limit—or even completely prevent—the hydrolysis of the ester formed and above all to shift the reaction equilibrium in the direction of acylation.

A process for acylation of such a solid material bearing such reactogenic hydroxyls, used on the laboratory scale is described in WO99/08784. In such a process, a piece of “Whatman no.2” filter paper is impregnated with a solution of fatty acid chloride in anhydrous pentane. The piece of filter paper is then placed under a suction hood at ambient temperature so as to remove the pentane by evaporation, then in a ventilated oven brought to a temperature of 150° C. Such an impregnation enables optimal contacting of the cellulose fibres of the sheet of paper with the fatty acid chloride, and acylation of all of said reactogenic hydroxyls present on the piece of filter paper. The piece of filter paper thus acylated has excellent hydrophobicity, as revealed by its water repellency properties. That being said, the process is difficult to implement in practice. The spontaneous evaporation of the pentane and the cooling which results therefrom lead to a condensation of atmospheric moisture on the filter paper, adding to the natural moisture of the paper. It is therefore essential to dry the paper by equilibrating at 105° C. for 24 hours and to carry the reaction out under low moisture conditions, for example in a conditioned air atmosphere. Under these conditions, remarkable hydrophobic properties are obtained using an amount of fatty acid chloride of the order of 0.1% relative to the weight of the paper. Under such conditions, a grafting yield of 50% is obtained using stearic acid chloride. Nothing prevents the moisture problem from being overcome by increasing the amount of stearic acid chloride so as to provide a sacrificial amount of stearic acid chloride. Such an approach is not however satisfactory as it leads to the formation of free stearic acid having amphiphilic properties. Such an approach also necessitates removing the excess stearic acid chloride at the end of the reaction. Indeed, an excess of residual stearic acid chloride poses a problem. It is capable of being hydrolysed and of producing free fatty acid and hydrochloric acid (HC [symbol] ). The presence of HC [symbol] weakens the paper by hydrolysis of glycosidic bonds of the cellulose. The free fatty acids themselves tend to reduce the hydrophobicity of the paper owing to their surfactant properties. Solutions for maintaining an optimal quality of the grafting and optimal hydrophobicity properties by limiting the formation of moisture and by limiting—or even by completely eliminating—the amount of residual free fatty acid chlorides and acids are therefore sought.

Moreover, the process described in WO99/08784 inevitably involves using a solution of fatty acid chloride in a nonpolar solvent medium of pentane, hexane or petroleum ether type, which are solvents that may be toxic for humans and/or for the environment. Pentane being highly volatile obviously poses the problem of its high flammability which makes it unusable in practice, notably on an industrial scale.

One solution that aims to overcome at least some of these drawbacks is to replace the highly volatile pentane with a less volatile nonpolar solvent, such as petroleum ether 100/150. However, although the evaporation of petroleum ether 100/150 is not accompanied by significant condensation of moisture, on the other hand, a fraction of this petroleum ether 100/150 inevitably remains trapped in contact with the cellulose fibres of the paper material. The inventor has specifically observed that the removal of petroleum ether 100/150 by evaporation at 150° C. is slow and incomplete. The inventor has visualized the residual presence of petroleum ether 100/150 by the occurrence of a fog of condensation formed upon opening an oven containing a filter paper impregnated with petroleum ether 100/150 and heated at 150° C. The inventor believes that this fog of condensation is caused by the mixture of hot air from the oven and external cold air, and the cooling thereof. An excess of fatty acid chloride may also be revealed by the formation of such a fog of condensation. Moreover, the inventor observed that the chromatogenic reaction itself is adversely affected by the presence of residues of petroleum ether 100/150. Specifically, in order to obtain a contact angle value of the order of 150° it is necessary to use an amount of fatty acid chloride at least five times higher than the amount of fatty acid chloride needed to achieve this result with a solution of fatty acid chloride in pentane in a weight proportion of 0.1%. The inventor believes that the presence of these residual fractions of petroleum ether 100/150 slows down the reaction by keeping the fatty acid chloride in the at least partially solvated state and by not allowing a reduction in the activation energy of the reaction. Higher concentrations of reactant would then be essential. The presence of such residual fractions of petroleum ether 100/150 is also capable of leading to an acylation of the deep fibres of the paper material.

This method of acylation by impregnation of a solution of a fatty acid chloride in petroleum ether 100/150 is described in FR2925910 for the treatment of papers coated with a layer of polyvinyl alcohol (PVA). This method of acylation using a fatty acid chloride in solution in petroleum ether makes it possible to render the PVA layer hydrophobic, but the inventor has found that a better hydrophobicity result could be obtained with a method of impregnation by pentane with a lower concentration of fatty acid chloride. These methods of treatment by impregnation are furthermore unsuitable for the treatment of a nonporous coated paper, since it is desirable to deposit the fatty acid chloride only on the coated side and not to needlessly impregnate the whole of the paper.

The invention therefore aims to overcome these drawbacks.

In particular, the invention aims to provide a process for acylation of a solid material bearing reactogenic hydroxyls that makes it possible to obtain an acylated material having high hydrophobicity and which is substantially free of residual fatty acid chloride and of residual fatty acid. The invention therefore aims to provide such a process which is simplified as it does not necessitate eliminating residual excess fatty acid chloride.

The invention also aims to provide such a process which is more energy efficient than the known acylation processes since it does not necessitate the establishment of a stream of hot air for elimination of this excess fatty acid chloride.

Moreover, the invention aims to provide such a process which is economical in that it makes it possible to reduce the amount of fatty acid chloride to be applied to the paper material, for a hydrophobicity at least equal to, or even increased, relative to a paper material obtained by a known acylation process.

A process for acylation of a hydroxylated substrate capable of being used on an industrial scale is described in FR2967363. FR2967363 describes the continuous acylation of a strip of a cellulosic material such as paper or cardboard, moved between a reel and a device for rewinding a strip of acylated cellulosic material. The problem solved by FR2967363 is that of enabling a deposition of fatty acid chloride on the surface of a moving cellulosic material. The solution of FR2967363 consists in depositing the fatty acid chloride in contact with the moving cellulosic material, by a printing technique then in heating the deposit by contact with a heating roller. In the process of FR2967363, the fatty acid chloride is deposited on the surface of the moving cellulosic material in the form of a plurality of clusters corresponding to the cells of an anilox roller of a flexographic or heliographic printing device.

Flexographic and heliographic deposition devices are suitable for the printing techniques and the inventor has observed that even though they work partially, they are not optimized for the purposes of the chromatogenic reaction. Owing to the minimum size of the cells of an anilox roller, it is not possible to sufficiently limit the amount of fatty acid chloride deposited on the cellulosic material to the amount of fatty acid chloride required by chromatogeny. Hence, the use of the process of FR2967363 gives rise to the appearance of a fog of condensation forming above the cellulosic material brought to high temperature on the heating roller, this fog of condensation characterizing the excess acid chloride deposited on the cellulosic material. Furthermore, the inventor has observed that the use of the process of FR2967363 systematically results in an acylated cellulosic material having a hydrophobicity value lower than that which can be obtained by impregnation with a solution of fatty acid chloride in pentane carried out under controlled atmospheric moisture conditions. Not only is the amount of fatty acid chloride deposited excessive, but this amount is not deposited uniformly over the entire specific surface area of the cellulosic material. On the contrary it is deposited in the form of discrete clusters, each cluster corresponding to a printing pixel. Unlike the method of impregnation by a solution of pentane which results in a substantially uniform deposition of a monolayer of fatty acid chloride on the surface of the filter paper, these clusters are formed from a large number of molecules, having a low specific surface area that is unfavourable for shifting the liquid/vapour equilibrium towards the gaseous form. Such clusters necessitate, for this shift, applying a higher temperature which in reality is detrimental to the characteristic condensation/evaporation of chromatogeny. The hydrophobicity values obtained are not therefore optimal. The hydrophobicity of the resulting acylated cellulosic material does not make it possible to give it an optimal impermeability to water that is sufficiently durable over time. In this regard, the contact angle value of a drop of pure water deposited on a cellulosic material acylated according to the process of FR2967363 is certainly greater than 90°, but this value does not reach the optimal value of 150°. It was also observed that this acylated cellulosic material contains a large proportion of free fatty acids contributing to the degradation of its hydrophobicity and water impermeability properties.

The inventor also believes that the deposition of fatty acid chloride deposited in the form of such clusters (FR2967363) leads to the formation of a fatty layer not bound to the cellulosic material, trapping the water contained in the volume of the cellulosic material and opposing the removal thereof. This would result in an undesired hydrolysis of the fatty acid chloride. The fact also of using an excess of fatty acid chloride results in an accumulation of volatile impurities associated with the fatty acid chloride—for example free fatty acids—which are not very volatile and risk accumulating on the cellulosic material.

Regarding the treatment of a gas-tight cellulosic material from which it is desired to treat only a single one of the two main faces, the process of FR2967363 appears to be more suitable than the pentane impregnation process, the fatty acid chloride being able to be deposited only on a single one of the two faces of the cellulosic material. However, the amount of fatty acid chloride deposited by a printing method is excessive and is distributed in a discontinuous manner The hydrophobicity properties obtained are lower than those obtained with the pentane impregnation method.

There is therefore no high-performance method for depositing fatty acid chloride on a cellulosic material that makes it possible to obtain an acylated material, the performance of which in terms of hydrophobicity is satisfactory.

The invention therefore aims to overcome these drawbacks.

The invention aims in particular to provide an artisanal process for acylation of a solid material bearing reactogenic hydroxyls which is improved compared to the process of WO99/08784 by impregnation of a solution of a fatty acid chloride in pentane.

The invention also aims to provide such an artisanal process for acylation without solvent that makes it possible to individually treat a piece of a solid material bearing reactogenic hydroxyls, notably a cellulosic material and in particular a paper material, with a grafting efficiency at least equal to, or even improved, relative to the grafting efficiency of the process of WO99/08784.

The invention also aims to provide such an artisanal process for acylation that does not necessitate using an organic solvent that is toxic for the environment.

The invention also aims to provide such an artisanal process for acylation that does not necessitate using a nonpolar organic solvent, irrespective of its volatility.

The invention also aims to provide such an artisanal process for acylation that is capable of being carried out by any individual with commonly accessible means.

The invention also aims to provide such an artisanal process for acylation of a cellulosic material, notably a paper material, for the individual manufacture of a filtration protection device, which is permeable to gases, notably permeable to atmospheric air, and impermeable to aqueous liquids.

In particular, the invention aims to provide such an artisanal process for acylation of a paper material for the manufacture of a mask for protection against pathogenic microorganisms (bacteria, fungi, viruses).

But the invention also aims to provide an industrial process for acylation of a moving web or strip of solid material bearing reactogenic hydroxyls, notably a cellulosic material and in particular a paper material.

The invention aims in particular to provide such an industrial acylation process having improved efficiency compared to the efficiency of the process of FR2967363.

The invention also aims to provide such an industrial acylation process which is simplified compared to the process of FR2967363.

The invention therefore aims to provide such an industrial acylation process that is compatible with the technical constraints relating to the running speed of the solid material bearing reactogenic hydroxyls, notably cellulosic material and in particular paper material, and to a high production rate of such an acylated solid material.

The invention also aims to provide such an industrial process for acylation of a web of cellulosic material, notably of paper material, for the manufacture of filtration protection devices, which are permeable to gases, notably permeable to atmospheric air, and impermeable to aqueous liquids.

In particular, the invention aims to provide such an industrial acylation process for the manufacture of masks for protection against pathogenic microorganisms (bacteria, fungi, viruses).

Thus, the invention relates to a process for acylation of a solid material bearing hydroxyls (—OH), referred to as reactogenic hydroxyls, which are accessible and capable of reacting with a fatty acid chloride in the gaseous state, in which:
at least one fatty acid chloride is distributed at least on the surface of said solid material, and if need be at depth over at least one thickness portion of said solid material, using a distributor device having an application surface suitable for depositing said at least one fatty acid chloride at least on the surface of said solid material from said application surface;
said at least one fatty acid chloride distributed at least on the surface of said solid material is heated, at a temperature, referred to as acylation temperature, below the vaporization temperature of at least one, notably of each, fatty acid chloride, so as to enable an acylation of said solid material by reaction of at least one fatty acid chloride in the gaseous state over at least one of said reactogenic hydroxyls of said solid material;
a stream of a gaseous composition, notably a stream of inert gaseous composition—atmospheric air, noble gas—which is inert with respect to acylation, is directed over said solid material at said acylation temperature, so as to entrain, at a distance from said solid material, at least one portion of gaseous hydrochloric acid formed by the acylation reaction;
characterized in that the application surface of the distributor device is a velvet provided with velvet filiform elements that are non-reactive with respect to said at least one fatty acid chloride and are suitable for:
   taking up said at least one fatty acid chloride by contact with said at least one fatty acid chloride, and;
   releasing said at least one fatty acid chloride by contact of the filiform elements of the velvet with said solid material;
      the distribution step being carried out so as to distribute over said solid material an amount of said at least one fatty acid chloride of between 20 mg/m² and 1 g/m² surface area of said solid material.

Such a solid material bearing hydroxyl groups (—OH), referred to as reactogenic hydroxyls, which are accessible and capable of reacting with a fatty acid chloride in the gaseous state, may be a cellulosic material. It may be a paper or cardboard material. In certain embodiments, said solid material may be a fabric. Advantageously, said solid material has an irregular and very rough surface appearance. Such a solid material may be porous or nonporous. Nothing however prevents said solid material from being a calendered paper material having a regular surface appearance of low roughness. It may also be a nonporous solid material having reactogenic hydroxyls borne by at least one polymer bearing such reactogenic hydroxyls. Such a polymer may be PVA (polyvinyl alcohol). In certain embodiments, said solid material has an outer surface layer formed of polyvinyl alcohol. In particular, it may be a cellulosic material, in particular a paper material, rendered airtight and nonporous by surface application of a PVA layer, as described in FR2925910.

The inventor has discovered that the process according to the invention makes it possible to deposit, at least on the surface of said solid material, that is to say on the surface and if need be over at least one thickness portion of said solid material, notably when said solid material is porous and/or has an irregular surface, an amount of at least one fatty acid chloride at least equivalent to, or even lower than, the lowest amounts of fatty acid chloride deposited during the implementation of the process by impregnation of a solution of fatty acid chloride in pentane (WO99/08784) and while resulting in hydrophobicity properties, notably in hydrophobicity properties as quantified by the measurement of the Cobb index and/or by the measurement of the contact angle formed by a drop of water deposited on the surface of said acylated solid material and/or by the tightness test of a pocket of water, that are substantially equivalent, or even improved.

The inventor has furthermore discovered that the reaction conditions of the known processes of chromatogenic acylation of a solid material using petroleum ether 100/150 or a deposition of substantially pure fatty acid chloride by flexography or heliography are not optimal and use fatty acid chloride in excess relative to the solid material, so that the solid material treated by these known processes contains a significant residual amount of free fatty acid chloride. The inventor has discovered that the solid material treated by these known processes contains a residual amount of fatty acid chloride, despite the use of a final blowing (or flushing) step intended to eliminate any residue of fatty acid chloride. The presence of residual fatty acid chloride poses the problem of the elimination of this residue of fatty acid chloride. Specifically, such a residual free fatty acid chloride may decompose by hydrolysis in the form of free fatty acid and hydrochloric acid capable of degrading the solid material. In addition, these reactive residual fatty acid chlorides constitute a problem of toxicity for applications in food packaging and in the biomedical field.

Furthermore, the fact that the hydrophobicity properties of a paper material treated by known processes of impregnation by petroleum ether 100/150 and by application using an anilox roller are lower than those hoped for would encourage increasing the amount of fatty acid chloride deposited on said solid material for the purposes of increasing the degree of grafting. However, the inventor has become aware that it is not so much the total amount of fatty acid chloride deposited on said solid material that matters, but rather the distribution and spreading as uniformly as possible of this fatty acid chloride over the entire surface and if need be at depth in said solid material—notably when said solid material is porous and/or has an irregular surface—and the absence of residual solvent. In reality, according to the invention, the fact of depositing a limited amount of fatty acid chloride on said solid material makes it possible, while improving the hydrophobicity properties, to decrease, or even eliminate, the amount of residual fatty acid chloride, improving the economic yield of the reaction and avoiding the complex implementation of a treatment for eliminating the excess acid chloride. The fact of reducing, or even of eliminating, the excess of fatty acid chloride makes it possible to reduce, or even to eliminate, the free fatty acid capable of being produced by hydrolysis and which cannot be eliminated by hot air blowing. The process according to the invention is therefore simplified, more effective and more economical than the known processes.

The inventor has observed that, quite surprisingly and unexpectedly, it is possible to distribute, in a regular, reproducible and uniform manner, a small amount of fatty acid chloride on the surface of said solid material using a distributor device having an application surface formed of a velvet provided with filiform elements of the velvet. Even more surprisingly, these small amounts of fatty acid chloride are however sufficient to make it possible to impart to the solid material a hydrophobicity, an impermeability to aqueous liquids and a water repellency that are at least equal, or even generally greater than the hydrophobicity, impermeability and water repellency of an acylated solid material obtained by a known process, notably by a process by impregnation of a solution of fatty acid chloride in pentane (WO99/08784).

By way of comparison, the inventor has observed that the use of a distributor device having an application surface formed of a foam free of filiform elements (which does not therefore constitute the invention) does not make it possible to obtain such properties with the same amount of fatty acid chloride. Such a foam is certainly deformable on the macroscopic scale, but has, on the microscopic scale, a high cohesion and a low deformability which do not enable a close contact with all the surface micro-irregularities of said solid material, as the filiform elements of a velvet can do. The foam loaded with fatty acid chloride adheres to the solid material, does not have the slippery effect of the velvet and the use thereof on an industrial scale is tricky or even impossible.

In certain embodiments of a process according to the invention, said solid material being a porous solid material, at least one fatty acid chloride is distributed at least on the surface of said porous solid material and at depth over at least one thickness portion of said porous solid material, using the distributor device. The distribution step is carried out so as to form, on said solid material, a deposit of said at least one fatty acid chloride as spread out as possible—and of thinnest possible thickness considering the amounts deposited—in contact with said reactogenic hydroxyls of the solid material. This spreading and this thin thickness of the deposit favour the gaseous state of the fatty acid chloride. The chromatogenic acylation reaction then takes place efficiently.

In certain embodiments according to the invention, the distributor device has an application surface formed of a velvet provided with velvet filiform elements that are oleophilic (having an affinity for fatty substances). Nothing however prevents, in other embodiments according to the invention, the distributor device from having an application surface formed of a velvet provided with oleophobic velvet filiform elements. In particular, they may be velvet filiform elements coated with a perfluorinated coating, notably Teflon®. Surprisingly, the inventor has observed that such oleophobic velvet filiform elements, despite their oleophobicity, take up fatty acid chloride which is of lipidic and oleophilic nature. The amount of fatty acid chloride taken up is certainly low but it is sufficient to enable a deposit and a distribution of fatty acid chloride on the solid material and the hydrophobization thereof.

According to the invention, the application surface of the applicator roller is formed of a chemically stable, abrasion resistant and heat resistant material. Any type of suitable lipophilic material may be used. Advantageously, the applicator roller is of “varnish roller” type.

In certain embodiments of a process according to the invention, the distribution step is carried out at a temperature between 40° C. and 190° C. In certain embodiments of a process according to the invention, nothing prevents the deposition and the distribution of said at least one fatty acid chloride from being carried out on a solid material that is preheated in order to reach said acylation temperature. It is observed that the acylation reaction takes place virtually instantaneously during the distribution of said at least one fatty acid chloride. Nothing prevents, in certain embodiments of an acylation process according to the invention—notably in certain embodiments in which the solid material has a high moisture content—the solid material from being heated prior to the deposition of said at least one fatty acid chloride or prior to the distribution step.

Advantageously, the velvet filiform elements are flexible and suitable for taking up said at least one fatty acid chloride and for releasing at least one portion of said at least one fatty acid chloride loaded on the velvet filiform elements on the surface and optionally over at least one thickness portion of said solid material, by elastic deformation of the loaded flexible velvet filiform elements.

In certain embodiments, the velvet filiform elements are formed of at least one material chosen from the group formed of keratin fibres—notably wool fibres, in particular mohair wool fibres—aramid fibres, polyester fibres, polyamide fibres, acrylic fibres, fluorinated, notably perfluorinated, fibres, fibres provided with a fluorinated, notably perfluorinated, coating, microfibres, notably microfibres with a linear density of less than 1 g/10 km (1 decitex), woven microfibres, super-microfibres, the count of which is less than 0 4 decitex and also ultra-microfibres, the count of which is less than 0.1 decitex. Advantageously, the velvet filiform elements are chosen for their chemical inertness and for their high resistance to heat and abrasion. In certain embodiments, the velvet filiform elements have a length of between 1 mm and 10 mm, notably between 2 mm and 6 mm, preferably of the order of 4 mm. In certain embodiments, the velvet filiform elements have a transverse cross-section having a diameter between 1 μm and 100 μm. In certain embodiments of an acylation process according to the invention, the velvet filiform elements have an implantation density on the surface of the applicator roller of between 10 filiform elements per mm² surface area of the applicator roller and 500 filiform elements per mm² surface area of the applicator roller. The velvet filiform elements are chosen to have, notably during the rotation of the applicator roller, a stiffness imparted owing to the rotation of the applicator roller, which is sufficient to enable the application of said at least one fatty acid chloride at depth over at least one thickness portion of said solid material, notably of said porous solid material, without however damaging said solid material. Advantageously, according to all the embodiments of a process according to the invention, the velvet filiform elements have a flexibility chosen so as not to damage said solid material by contact with said solid material.

In certain embodiments of a process according to the invention, said at least one fatty acid chloride is distributed at least on the surface of said solid material by brushing of free longitudinal ends of the velvet filiform elements of the application surface over the surface of said solid material. In particular, said at least one fatty acid chloride is distributed at least on the surface of the solid material by relative displacement of the application surface of the distributor device and of the solid material so that the free ends of velvet filiform elements are in contact with said solid material at least on the surface of said solid material and preferably in contact with at least one thickness portion of the solid material, notably when the latter is porous, so that the velvet filiform elements release fatty acid chloride in contact with said solid material. Advantageously, said at least one fatty acid chloride is distributed at least on the surface of said solid material by brushing while applying to said solid material a sufficient pressure to enable a transfer of fatty acid chloride between the filiform elements of the velvet and said solid material, but without deterioration of the solid material.

In certain embodiments of a process according to the invention, the distributor device comprises at least one applicator roller having said application surface. Said at least one applicator roller is rotatably mounted with respect to said solid material and said at least one fatty acid chloride is distributed by rotating said at least one applicator roller, said application surface being in contact with said solid material. In certain particular embodiments according to the invention, nothing prevents said at least one fatty acid chloride from being distributed on the surface of said solid material by means of an applicator roller rotated by rolling of the application surface of the applicator roller over the surface of said solid material.

In a first industrial-scale embodiment of a process according to the invention, said solid material being in the form of a strip moved in a run direction parallel to the largest dimension of the strip, between a reel upstream of said strip and a take-up roll downstream of a strip of acylated solid material;
said at least one fatty acid chloride is deposited continuously, notably at a fixed station, on at least one free face of said moving solid material, and;
said at least one fatty acid chloride deposited on the surface of said solid material is distributed at least on the surface of said solid material by means of the distributor device, and;
said solid material is heated so that said at least one fatty acid chloride distributed at least on the surface of said solid material reaches said acylation temperature on said solid material, and;
the stream of gaseous composition is directed over said solid material at said acylation temperature, whereby said solid material is acylated.

The inventor has determined that the process according to the invention can be used on industrial scale on a strip of said solid material that is moved, notably at high run speed, greater than 50 m/min. According to certain embodiments, the applicator roller is rotated about an axis of rotation:
extending in a plane parallel to the main plane of the strip, and;
substantially orthogonal to the run direction of said solid material.

Nothing prevents, according to other embodiments, the applicator roller from being rotated about an axis of rotation:
extending in a plane parallel to the main plane of the strip, and;
not orthogonal and not parallel to the run direction of said solid material.

In this first industrial-scale embodiment of a process according to the invention, said at least one acid chloride is deposited continuously, notably at a fixed station, on at least one of the free main surfaces of said solid material by means of a printing device. In this first industrial-scale embodiment of a process according to the invention, the printing device is chosen from the group formed of flexographic printing devices and heliographic printing devices.

In certain particular embodiments according to the invention, nothing prevents provision being made to carry out the distribution of said at least one acid chloride on a moving strip of said solid material, by means of two applicator rollers rotatable about mutually parallel axes of rotation, each of the opposite main faces of the strip of said solid material being in contact with one of the rollers, at least one of the rotatable applicator rollers having an application surface provided with velvet filiform elements.

In a second industrial-scale embodiment of a process according to the invention, said solid material being in the form of a strip moved in a run direction parallel to the largest dimension of the strip, between a reel upstream of said strip and a take-up roll downstream of a strip of acylated solid material;
said at least one fatty acid chloride is deposited continuously on the applicator roller rotated in contact with said solid material, whereby said at least one fatty acid chloride is distributed at least on the surface of said solid material from the rotated applicator roller, and;
said solid material is heated so that said at least one fatty acid chloride distributed at least on the surface of said solid material reaches said acylation temperature, and;
the stream of gaseous composition is directed over said solid material at said acylation temperature.

In this second industrial-scale embodiment of a process according to the invention, said at least one fatty acid chloride is deposited on the rotated applicator roller, by contact of said rotated applicator roller with an anilox roller of a printing device, loaded with said at least one fatty acid chloride. Any type of anilox roller can be used. It may be chosen from the group formed of flexographic printing devices and heliographic printing devices. Any type of anilox roller may be used by adapting the dimensions of its cells and their surface density to the amount of fatty acid chloride to be deposited. Nothing prevents the anilox roller from having a rotational speed different from the rotational speed of the applicator roller.

In certain industrial-scale embodiments of a process according to the invention, the rotatable applicator roller is rotated with an angular speed of rotation chosen so that the free ends of the velvet filiform elements are rotated with a linear speed having a value different from the value of the run speed of said solid material. In these embodiments, the linear run speed of the free ends of the velvet filiform elements and the run speed of said solid material are not synchronized so as to produce a brushing on said solid material leading to a spreading of said at least one fatty acid chloride at least on the surface of said solid material.

In certain industrial-scale embodiments of an acylation process according to the invention, the rotatable applicator roller is rotated in a direction of rotation chosen so that the free ends of the velvet filiform elements are moved countercurrent to the movement of the strip of said solid material. Nothing however prevents, in other industrial-scale embodiments of an acylation process according to the invention, the rotatable applicator roller from being rotated in a direction of rotation chosen so that the free ends of the velvet filiform elements are moved concurrent (in the same direction and the same sense) to the movement of said solid material.

The inventor has also determined that the process according to the invention can be carried out on an artisanal scale. In one artisanal embodiment of an acylation process according to the invention, said at least one acid chloride is deposited on the surface of said solid material by means of a distributor device having an application surface previously loaded with said at least one fatty acid chloride. In this artisanal embodiment of an acylation process according to the invention, the distributor device comprises an applicator roller or “varnish roller” and an amount of said at least one fatty acid chloride is deposited in a flat-bottomed container and said at least one fatty acid chloride is loaded on the velvet filiform elements of the applicator roller by rolling the applicator roller in contact with said at least one fatty acid chloride. In these embodiments, the applicator roller is moved with rotary movement alternating with a back-and-forth movement imparted manually to the distributor device. In these embodiments of a process according to the invention, said at least one fatty acid chloride is loaded on the velvet filiform elements by rolling and compression of the applicator roller in contact with the flat bottom of the container.

In some of these embodiments of an acylation process according to the invention, said solid material is a flexible material, that is to say that it is capable of deforming under the effect of its own weight. In some of these embodiments, said solid material may be a paper material (that is to say an essentially cellulosic material) in the form of a sheet of paper referred to as “kitchen roll”, toilet paper, a paper serviette, a filter paper. Nor does anything prevent said solid material being chosen from the group formed of crosslinked paper materials in which the rotational mobility of the cellulose fibres thus crosslinked is restricted and of which the mechanical strength properties in general and wet strength properties in particular are improved.

In certain embodiments of an acylation process according to the invention, said solid material is a paper material (that is to say an essentially cellulosic material) formed of all or part of a disposable tissue. In some of these embodiments, said solid material is a disposable tissue. In some of these embodiments of a process according to the invention, said solid material is formed of a plurality of cellulosic layers having a grammage of less than 30 g/m², notably less than 20 g/m², preferably between 10 g/m² and 30 g/m², more preferentially between 10 g/m² and 20 g/m². Advantageously, in some of these embodiments, each cellulosic layer is formed of crosslinked cellulose fibres, bound together by hydrogen bonds and by covalent bonds formed with at least one group of crosslinking atoms. Advantageously, the crosslinking atom group is a derivative of 1-chloro-2,3-epoxypropane (epichlorohydrin).

In certain other embodiments of an acylation process according to the invention, said solid material is rigid, that is to say that it is not capable of deforming substantially under the effect of its own weight. In these other embodiments, said solid material may be a piece of cardboard, notably of corrugated cardboard. In these other embodiments, said solid material is formed of layers of cellulose having a grammage of greater than 160 g/m².

In certain embodiments of an acylation process according to the invention, said acylation temperature is between 140° C. and 200° C. The value of said acylation temperature is chosen with regard to the vaporization temperature at atmospheric pressure of each fatty acid chloride.

In certain embodiments of an acylation process according to the invention, at least one fatty acid chloride is chosen from the group formed of acid chlorides of formula R—CO—C [symbol] in which R is a hydrocarbon-based chain having a number of carbon atoms of between 17 (limit included) and 29 (limit included), notably between 21 (limit included) and 29 (limit included). Advantageously, at least one fatty acid chloride is behenic acid chloride (C₂₂H₄₃OC [symbol] ). Advantageously, at least one fatty acid chloride is palmitic acid chloride (C₁₆H₃₁OC [symbol] ). Advantageously, at least one fatty acid chloride is stearic acid chloride (C₁₈H₃₅OC [symbol] ).

In certain embodiments of an acylation process according to the invention, a composition, referred to as acylation composition, formed exclusively of said at least one fatty acid chloride is distributed at least on the surface of said solid material—and if need be at depth and over at least one thickness portion of said solid material. In these embodiments, said acylation composition is free (with the exception of possible traces) of any solvent medium, notably of any nonpolar solvent medium different from the fatty acid chloride(s).

That being said, nothing prevents, in other embodiments, said acylation composition from comprising said at least one fatty acid chloride and acetyl chloride. The inventor has discovered that acetyl chloride, which is not a fatty acid chloride within the meaning of the invention, is capable of reacting spontaneously with free water molecules present in said solid material and makes it possible to protect the fatty acid chlorides from hydrolysis. The inventor has also observed, surprisingly, that acetyl chloride does not react with the hydroxyl groups of the cellulose fibres of the paper material under the conditions for acylation of the paper material and does not enable the acetylation of the cellulose under the chromatogenic reaction conditions, nor does it react with said reactogenic hydroxyls of other hydroxylated polymers such as polyvinyl alcohol. Advantageously, acetic acid, which is the hydrolysis product of acetyl chloride, is sufficiently volatile and is suitable for being eliminated from said solid material by entrainment by the stream of gaseous composition. Advantageously, acetyl chloride is used as a protector of the fatty acid chloride(s). Advantageously, acetyl chloride is used as a transchlorination reagent that makes it possible to restore fatty acid chlorides from possible free fatty acids hydrolysed during the reaction.

The invention also relates to an acylated solid material capable of being obtained by a process according to the invention.

The invention also relates to a process for acylation of a solid material bearing hydroxyl groups (—OH), referred to as reactogenic hydroxyls, which are accessible and capable of reacting with a fatty acid chloride in the gaseous state, characterized in combination with all or some of the characteristics mentioned above or below. Irrespective of the formal presentation which is given thereof, unless explicitly indicated otherwise, the various characteristics mentioned above or below should not be considered to be closely or inextricably linked with one another, the invention being able to relate to only one of these structural or functional characteristics, or one portion only of these structural or functional characteristics, or one portion only of one of these structural or functional characteristics, or else any group, combination or juxtaposition of all or some of these structural or functional characteristics.

Other objectives, characteristics and advantages of the invention will become apparent on reading the following description which refers to the appended figures and to the examples given purely without limitation of the invention and in which:

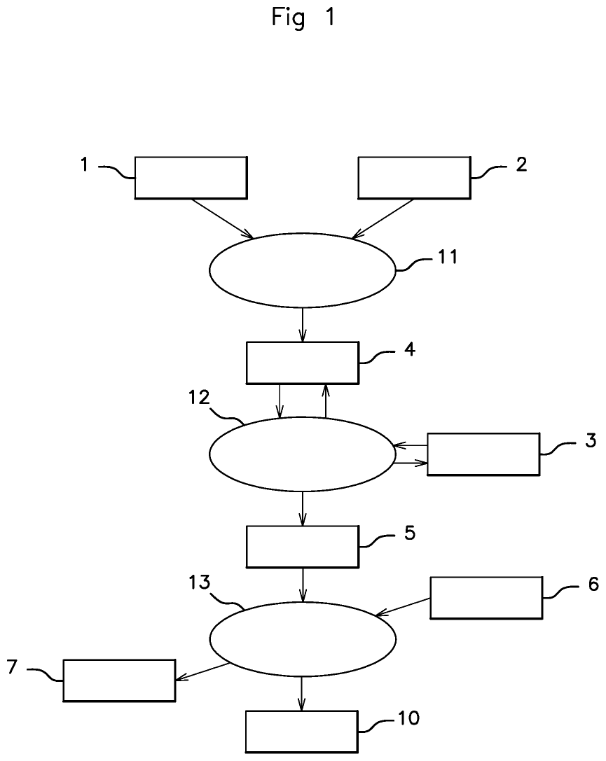

FIG. 1 is a synoptic diagram illustrating a first embodiment of a process according to the invention, and;

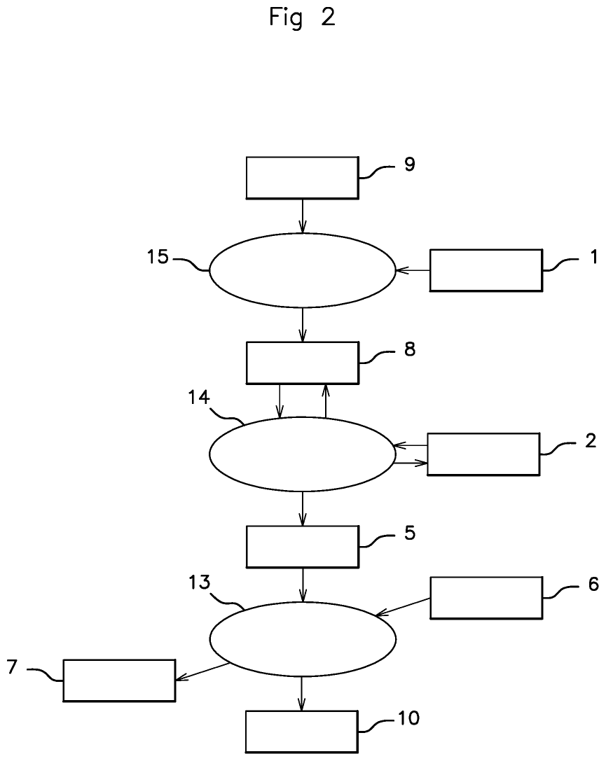

FIG. 2 is a synoptic diagram illustrating a second embodiment of a process according to the invention capable of being carried out on an industrial scale.

In a process according to the invention for acylation of a solid material bearing hydroxyl groups (—OH), referred to as reactogenic hydroxyls, which are accessible and capable of reacting with a fatty acid chloride in the gaseous state, notably for acylation of a cellulosic material, in particular of a paper material, at least one fatty acid chloride is distributed on the surface and over at least one thickness portion of said solid material by means of a distributor device having an application surface suitable for depositing said at least one fatty acid chloride from said application surface at least on the surface of said solid material. The application surface of the distributor device is a velvet provided with velvet filiform elements that are not reactive with respect to said at least one fatty acid chloride. The applicator device comprises at least one applicator roller having said application surface, said at least one applicator roller being rotatably mounted relative to the flat material. The applicator roller may be an applicator roller or “varnish” roller of “velvet” type. By way of nonlimiting example, it may be:
a “Nespoli” velvet roller (Nespoli Group, La Capelle, France), the application face of which is formed of a velvet provided with filiform elements comprising textile fibres coated with Teflon® and that are at least partially oleophobic. For example, such a velvet roller has a length of the order of 10 cm and a diameter of 30 mm. The length of the fibres is between 4 mm and 12 mm, and preferably of the order of 5 mm;
a “DIALL” varnish roller (Kingfisher International Products Limited, London, Great Britain), the application surface of which is of cylinder of revolution shape, having a length of 110 mm and having a transverse cross-sectional diameter of 40 mm and the application face of which comprises mohair fibres;
a “Roulor Professionnel” varnish roller (Nespoli Group, La Capelle, France), the application face of which is formed of a velvet provided with filiform elements comprising polyester fibres coated with Teflon® and that are at least partially oleophobic;
a pure wool velvet roller (OCAI, Domont, France), the fibres of which have a length of 4 mm.

The inventors observed that the use of a step of distributing the acid chloride(s) over said solid material, by means of such an applicator roller of “varnish” or “velvet” type in a chromatogenic acylation process according to the invention makes it possible to obtain an acylated solid material having hydrophobicity properties at least equivalent, for the same amounts of reactant deposited, to the hydrophobicity properties of paper materials treated by the process for impregnation of the paper material with a solution of fatty acid chloride in pentane (WO99/08784), but with the considerable advantage of not using solvent, notably organic solvent. The hydrophobic properties obtained by the use of a process according to the invention are, at an equal amount of fatty acid chloride deposited, even better than those obtained with the method of impregnation by a solution of fatty acid chloride in petroleum ether 100/150 or with a deposition of fatty acid chloride by means of an anilox roller. These two prior art processes result in acylated solid materials, the hydrophobicity of which is disappointing, inevitably use excess fatty acid chloride and require a complex step of eliminating the excess fatty acid chloride by hot air blowing.

The quality of the acylation is defined by evaluating the hydrophobicity of the acylated solid material by measuring the contact angle formed between the main plane of the acylated solid material and a drop of pure water deposited on the surface of the acylated solid material. Typically, a contact angle value of an acylated solid material is between 90° and 150°, the contact angle value of 150° corresponding to a particularly hydrophobic and water-repellent material. The quality of the acylation is also defined by measuring the period of time during which the contact angle value of between 90° and 150° is maintained at ambient temperature and by the pocket of water test. The pocket of water test can only be carried out with a solid material in the form of a substantially square flexible sheet enabling the corners thereof to be gathered together to form a pocket of water. The impermeability of this pocket of water is analysed by monitoring the loss of water (taking into account the evaporation).

The hydrophobicity can also be evaluated by observation of the water repellency. 1 mL of distilled water is deposited on the surface of the solid material and it is observed whether the drop of water formed rolls over the surface, by clinging or not clinging to the surface of the solid material. A satisfactory water repellency corresponds to a contact angle of around 150°.

The inventor was able to observe that the value of the contact angle formed between the main plane of a solid material acylated by a process for impregnation of a solution of fatty acid chloride in pentane and by a process according to the invention is close to 150°, whereas the contact angle values measured on a solid material acylated according to a process for impregnation by a solution of fatty acid chloride in petroleum ether 100/150 and by deposition by means of an anilox roller are at most equal to 130°.

### Characterization of the Presence of Residual Fatty Acid Chloride during the Acylation—Revealing Test

The fact that the amount of fatty acid chloride deposited on a first piece of a solid material, referred to as piece to be acylated, reacts only partially or reacts completely with said solid material of said piece to be acylated is characterized by depositing on said piece to be acylated a given amount of fatty acid chloride and by placing in contact with the main face of said piece to be acylated, opposite the face for receiving the stream of hot air intended to promote the change of the fatty acid chloride from the liquid state to the gaseous state and to entrain the hydrochloric acid formed by the acylation reaction, a sheet of any paper, referred to as a revealing sheet. When the fatty acid chloride is present in excess, it is entrained by the stream of air into contact with said revealing sheet where it reacts with said reactogenic hydroxyls of the cellulose fibres. Said revealing sheet is analysed with respect to its hydrophobicity properties. If the given amount of fatty acid chloride placed in contact with said piece to be acylated is such that fatty acid chloride does not react with said piece to be acylated and is transported by the stream of air into contact with said revealing sheet, then the hydrophobicity properties of said revealing sheet are increased. If, on the contrary, the given amount of fatty acid chloride placed in contact with said piece to be acylated is such that most or all of the fatty acid chloride deposited on said piece to be acylated reacts with said piece to be acylated, then said revealing sheet remains barely or not at all hydrophobic.

It was observed that under conditions strictly comparable with those described in example 1 below, the acylation process according to the invention and also the process for acylation by impregnation using a solution of acid chloride at 0.1% in pentane do not result in an increase in the hydrophobicity of said revealing sheet. This result indicates that the fatty acid chloride reacts in the vast majority with said piece to be acylated. On the contrary, the process by impregnation in petroleum ether 100/150 and the process by flexographic/heliographic deposition require an excess of acid chloride and result in the formation of highly hydrophobic revealing sheets. The process according to the invention makes it possible to retain the excellent results obtained by the pentane impregnation method by depositing very small amounts of fatty acid chloride but with the considerable advantage of not using organic solvent.

A first embodiment of a process according to the invention for acylation of a paper material is represented schematically in FIG. 1. This first embodiment is an artisanal embodiment of a process according to the invention. This first embodiment may be carried out by a person without requiring particular equipment, utensils or protection which would not commonly be commercially available to him/her. In the embodiment of a process according to the invention for acylation of a solid material represented schematically in FIG. 1, at least one fatty acid chloride 1 is chosen from the group formed of fatty acid chlorides of formula R—CO—C [symbol] in which R is a hydrocarbon-based chain having a number of carbon atoms between 17 (limit included) and 29 (limit included). In such a process according to the invention, a distributor device 2 is also chosen that has an application surface suitable for depositing said at least one fatty acid chloride 1 from said application surface at least on the surface of said solid material. In the embodiment represented in FIG. 1, the distributor device 2 is a “DIALL” varnish roller 2 (Kingfisher International Products Limited, London, Great Britain), the application face of which comprises mohair fibres. Nothing however prevents the distributor roller from being a distributor roller having an oleophobic velvet, in particular of the type of an oleophobic velvet coated with Teflon®. An amount of fatty acid chloride 1 is placed in a flat-bottomed container sized in order to be able to receive the varnish roller 2, to enable the rolling thereof over the bottom of the container and the loading thereof with the fatty acid chloride 1.

During a first step 11 of loading the varnish roller 2, the varnish roller 2 being in the new state and not loaded with fatty acid chloride, an amount of the order of 1 mL of fatty acid chloride is placed in the flat-bottomed container. During this first step 11 of loading the varnish roller 2, the varnish roller 2 is driven manually so that the varnish roller 2 moves in contact with the fatty acid chloride 1 so that the filiform elements of the varnish roller 2 take up the fatty acid chloride 1 over the whole of the application surface of the varnish roller 2. For the purposes of limiting the amount of fatty acid chloride 1 loaded on the varnish roller 2, an optional step of removing an excess of fatty acid chloride 1 from the varnish roller 2 is carried out by rolling said varnish roller 2 successively over several sheets of paper so as to use up the excess fatty acid chloride. A varnish roller 4 loaded with fatty acid chloride 1 is thus obtained. Such a step of removing the excess fatty acid chloride 1 is in particular necessary during the use of a distributor roller having an oleophobic velvet.

That being said, during a subsequent step 11 of loading the varnish roller 2, the varnish roller 2 having been previously loaded and used for the application of fatty acid chloride on a solid material, an amount of fatty acid chloride of the order of 50 μL is placed in the flat-bottomed container.

A piece 3 of a solid material, for example a disposable tissue 3, is chosen. The piece 3 of paper material is placed on a suitable support so as to be able to transfer an amount of fatty acid chloride 1 from the loaded varnish roller 4 to the disposable tissue 3. This application 12 is carried out by rolling the thus loaded varnish roller 4 over the surface of the disposable tissue 3. Preferably, this rolling 12 is carried out without exerting pressure other than the pressure needed for rolling the varnish roller 4 over the disposable tissue 3 (that is to say a moderate pressure of between 0.1 and 0.2 kg/cm²). In this way, only a small amount of fatty acid chloride 1 is transferred onto the disposable tissue 3. However, the inventor has observed that even though this amount of fatty acid chloride 1 transferred onto the disposable tissue 3 is small, it is in any case sufficient to subsequently enable an acylation of the disposable tissue 3 and give it hydrophobicity properties at least equivalent to the hydrophobicity properties obtained by impregnation of a fatty acid chloride from a solution in pentane (WO99/08784), but without the use of organic solvent. Thus, a piece 5 of a disposable tissue loaded with fatty acid chloride 1 is formed. The inventor believes that the fatty acid chloride 1 applied on the surface of the disposable tissue 3 is distributed, owing to the filiform elements of the varnish roller 2, on the surface of the loaded disposable tissue 5 but also at least at depth in the loaded disposable tissue 5 and in contact with the cellulose fibres of the loaded disposable tissue 5. Specifically, the inventor believes that the filiform elements of the varnish roller 2 which are flexible and elastically deformable in a transverse manner make it possible to distribute the fatty acid chloride 1 by brushing over at least one thickness portion of the disposable tissue 3. The inventor believes that, taking into account the absence of solvent, the fatty acid chloride 1 does not form clusters during the evaporation of an organic solvent and is distributed substantially uniformly over the cellulose fibres of the loaded disposable tissue 5.

In the first embodiment of a process according to the invention represented in FIG. 1, the acylation reaction of the disposable tissue 3 is induced during a combined step 13 of heating the loaded disposable tissue 5 and applying a stream of air 6 at the surface of the loaded disposable tissue 5. The application of a stream of air 6 enables a shift of the liquid/vapour equilibrium of the fatty acid chloride 1 distributed over the loaded disposable tissue 5 and the formation of fatty acid chloride 1 in the gaseous state which is reactive with respect to the acylation reaction. Furthermore, the simultaneous heating of the loaded disposable tissue 5 makes it possible to reach the chromatogenic acylation temperature, via which the fatty acid chloride 1 in the gaseous state reacts with a free hydroxyl group of a cellulose fibre of the loaded disposable tissue 5 establishing an ester bond between said cellulose fibre and the acyl group of the fatty acid chloride 1, whereby the acylated tissue 10 is formed. Owing to the acylation reaction, hydrochloric acid (HC [symbol] ) is released. The stream of air 6 applied over the loaded disposable tissue 5 makes it possible to move hydrochloric acid formed by the reaction away from the loaded disposable tissue 5 so that the equilibrium of the acylation reaction is shifted in the direction of the formation of the acylated disposable tissue 10.

In the embodiment of a process according to the invention represented in FIG. 1, step 13 of heating and applying a stream of air 6 is carried out in a ventilated oven which is maintained at said acylation temperature. Owing to the ventilation, the acylated disposable tissue 10 is free of hydrochloric acid. Owing to the control of the amount of fatty acid chloride 1 loaded onto the disposable tissue 3 and the distribution of the fatty acid chloride 1 over the disposable tissue 3, the acylated disposable tissue 10 is devoid of free fatty acid chloride and free fatty acid. No subsequent step of eliminating an excess of fatty acid chloride 1 is necessary.

A second embodiment of a process according to the invention for acylation of a paper material is represented schematically in FIG. 2. This second embodiment is an industrial-scale embodiment of a process according to the invention.

A device for moving a strip 9 of a paper material moved between an upstream reel and a downstream device for rewinding a strip 10 of acylated paper is chosen as described in FR2967363. In certain embodiments, the strip 9 of paper material is moved at a speed of between 30 and 100 metres per minute. At least one fatty acid chloride 1 is chosen from the group formed of fatty acid chlorides of formula R—CO—C [symbol] in which R is a hydrocarbon-based chain having a number of carbon atoms between 17 (limit included) and 29 (limit included). A step 15 of continuously depositing said at least one fatty acid chloride 1 on the moving strip 9 of paper is carried out by any suitable means known to a person skilled in the art. These means may be an upstream printing device chosen from the group formed of flexographic printing devices and heliographic printing devices. Via this deposition step 15, a paper material 8 coated with fatty acid chloride 1 is formed. In the downstream position relative to the printing device, the paper material 8 coated with fatty acid chloride 1 is subjected to a step 14 of redistributing and spreading the fatty acid chloride 1 on the surface over at least one depth portion of the coated paper material 8. This redistribution/spreading step is carried out by subjecting the surface of the moving strip of coated paper 8 to a brushing with a distributor device 2 comprising an application surface formed of a velvet provided with velvet filiform elements that are not reactive with respect to said at least one acid chloride. Advantageously, the distributor device comprises a varnish roller 2 rotated countercurrent to or in the run direction of the strip of coated paper material 8. The velvet filiform elements, whether they are oleophilic or oleophobic, are suitable for:
taking up said at least one fatty acid chloride by contact with said at least one fatty acid chloride, and;
releasing said at least one fatty acid chloride by contact of the velvet filiform elements with the strip of coated paper material 8.

Owing to this redistribution/spreading step 14, a strip of solid material 5 loaded with an amount of said at least one fatty acid chloride is formed. The inventor observed in particular that even in the case where the amount of fatty acid chloride 1 transferred to the strip 5 of said solid material is small and of the order of 20 mg/m², it is in any case sufficient to subsequently enable an acylation of said solid material and to give it hydrophobicity properties at least equivalent to the hydrophobicity properties obtained by impregnation of a fatty acid chloride from a solution in pentane (WO99/08784), but without the use of organic solvent.

In the second embodiment of a process according to the invention represented in FIG. 2, the acylation reaction of said solid material of the moving strip is induced during a combined downstream step 13 of heating the loaded strip 5 and applying a stream of air 6 at the surface of the loaded strip 5. The application of a stream of air 6 enables a shift of the liquid/vapour equilibrium of the fatty acid chloride 1 distributed over the loaded strip 5 and the formation of fatty acid chloride 1 in the gaseous state which is reactive with respect to the acylation reaction. Furthermore, the simultaneous heating of the loaded strip 5 makes it possible to reach the chromatogenic acylation temperature, via which the fatty acid chloride 1 in the gaseous state reacts with a free hydroxyl of said solid material establishing an ester bond between a constituent of said solid material and the acyl group of the fatty acid chloride 1, whereby the strip of acylated solid material 10 is formed. Owing to the acylation reaction, hydrochloric acid (HC [symbol] ) is released. The stream of air 6 applied over the loaded strip 5 makes it possible to move hydrochloric acid formed by the reaction away from the strip 5 in the form of a composition 7 of air loaded with hydrochloric acid so that the equilibrium of the acylation reaction is shifted in the direction of the formation of the acylated paper material 10.

### EXAMPLE 1—ACYLATION ACCORDING TO THE INVENTION OF A SOLID MATERIAL—DETERMINATION OF OPTIMAL CONDITIONS FOR DEPOSITION OF STEARIC ACID CHLORIDE

Approximately 1 mL of undiluted stearic acid chloride is placed in a flat-bottomed tray. A varnish roller (“DIALL”, Kingfisher International Products Limited, London, Great Britain) is impregnated with stearic acid chloride by rolling the varnish roller over the bottom of the flat-bottomed tray. The varnish roller is of a cylinder of revolution shape having a diameter of 40 mm, a length of 100 mm and having filiform elements made of mohair wool having a mean length of 5 mm. The impregnation is homogenized by rolling the roller over the bottom of a flat container, whereby all of the stearic acid chloride is transferred to the varnish roller. A plurality of square disposable tissues (Kleenex®, Kimberly-Clark Corporation) with dimensions of 21 cm×21 cm are chosen. Each disposable tissue is formed of four superposed layers of paper, each layer having an approximate mass of 0.5 g (11 g/m²). Stearic acid chloride is deposited on one of the main faces of a first tissue, referred to as tissue to be acylated, of the plurality of disposable tissues by rolling the roller in contact with the whole of one of the two faces of this first tissue and by applying to the varnish roller a moderate pressure suitable for enabling a partial squashing of the filiform elements of the roller. To do this, a substantially vertical force directed from top to bottom and having a value between of the order of 5 N and of the order of 20 N is exerted on the roller, while making sure not to deteriorate the tissue. Stearic acid chloride impregnated on the varnish roller is thus deposited successively on one face, referred to as deposition face, of each of the tissues of the plurality of tissues to be acylated and without reloading the varnish roller. After deposition of the stearic acid chloride, a virgin disposable tissue, referred to as revealing tissue, is placed on the face opposite said deposition face of each tissue to be acylated, and each assembly formed of the tissue to be acylated surmounted by said corresponding revealing tissue is introduced into a ventilated oven at 150° for 2 minutes. Each pair of tissues formed of a tissue to be acylated and said corresponding revealing tissue is removed from the ventilated oven. After cooling, the hydrophobicity of said deposition face of the tissue to be acylated and the hydrophobicity of the face opposite said deposition face are analysed. The hydrophobicity of said revealing tissue is also analysed. It is observed that both faces of the tissues of the plurality of successively impregnated tissues have a high hydrophobicity revealed by a constant contact angle with water of 150° over the entire surface of the tissue. The hydrophobicity of said revealing tissue is initially high which indicates that the amount of stearic acid chloride deposited on the first tissues in their order of impregnation is greater than the maximum amount of stearic acid chloride capable of being grafted to such a tissue. However, it is observed that this hydrophobicity decreases with the impregnation placement of the tissue and becomes heterogeneous. This indicates that the roller is less and less loaded with reactant. The successive impregnation of tissues in series makes it possible to obtain acylated tissues that have an excellent hydrophobicity and at the same time a low hydrophobicity on said corresponding revealing tissue. The roller is in that case optimally loaded with stearic acid chloride. It is observed that it is possible to continue to deposit stearic acid chloride on a large number of tissues without the hydrophobicity obtained decreasing substantially.

### EXAMPLE 2—QUANTIFICATION

A tissue is weighed with a precision balance before deposition and after deposition of stearic acid chloride with the roller loaded with stearic acid chloride in an optimal manner as described in example 1. A value of 1 mg of stearic acid chloride per face on average is found. A value of 2 mg is found when the stearic acid chloride is deposited on both faces. The amount of stearic acid chloride deposited is of the order of 45 mg/m² of solid material; the hydrophobicity properties are excellent without the use of a nonpolar solvent of pentane type.

### EXAMPLE 3—REPRODUCIBILITY

After having carried out a first deposition of stearic acid chloride and determined the amount deposited by weighing, the operation is repeated 4 times, weighing the tissue each time. It is observed that each deposition of stearic acid chloride results in an additional increase of 1 mg. An amount of 5 mg was thus deposited. This example shows that the deposition of stearic acid chloride by means of a roller is reproducible.

### EXAMPLE 4—OPTIMIZATION OF THE LOADING OF THE ROLLER

The operation for loading the roller as in example 1 is repeated with the deposition of the stearic acid chloride but without applying said revealing tissue. After one minute in the oven at 150° C., the door is opened. During the heating of the first tissues, a fog of condensation is observed. This then decreases gradually with the tissues treated. When it is observed that the fog of condensation has practically disappeared, the tissue is tested for its hydrophobicity and it is observed that the face on which the stearic acid chloride was deposited has a very high hydrophobicity and contact angles of 150°. When the roller loading operation is carried out with 1 mL of stearic acid chloride, the placement of the first tissue of the plurality of tissues to be acylated on which the roller is successively applied and which does not lead to a formation of fog of condensation is in the vicinity of the 30^{th} placement.

### EXAMPLE 5—IMPERMEABILITY

The impermeable nature of the acylated disposable tissues is demonstrated by suspending each square disposable tissue by its four corners and by pouring an amount of water (10 mL) into the tissue pocket thus formed. The pockets of acylated disposable tissues which were prepared with the roller loaded in an optimal manner as described in example 1 are perfectly watertight over a period of more than 4 days.

### EXAMPLE 6—COMPARATIVE EXAMPLE (OUTSIDE THE INVENTION)

100 mL of a solution of stearic acid chloride at 0.05% in anhydrous pentane is prepared that makes it possible to impregnate 10 square disposable tissues (Kleenex®, Kimberly-Clark Corporation) with dimensions of 21 cm×21 cm, each disposable tissue retaining around 5 μl of stearic acid chloride. The pentane is eliminated by spontaneous evaporation under a suction hood with dry air having a moisture content of lower than around 20%. No step according to the invention for distributing the stearic acid chloride on the disposable tissues is carried out. Next, one of the disposable tissues is placed in a ventilated oven at a temperature of 150° C. The reaction is left to take place for 2 minutes. Upon opening the door of the ventilated oven, no formation of a fog of condensation of free stearic acid chloride is observed. The disposable tissue obtained is hydrophobic and impermeable to water. A 200 μL drop of distilled water is deposited on the surface of one of the acylated disposable tissues. The drop of water remains formed on the surface of the tissue without spreading. The contact angle has a value close to 150°, attesting to a correct grafting efficiency. A virgin tissue, referred to as a revealing tissue, is placed on top of a second tissue as prepared above, and the assembly is placed in the ventilated oven at 150° C. for 2 minutes. Said revealing tissue is tested with respect to its hydrophobicity and it is observed that this is very low. These two results confirm the fact that when appropriate but very small amounts are applied with the pentane impregnation method, good hydrophobicity values are obtained without excess stearic acid chloride. The invention aims to obtain such hydrophobicity values without the use of organic solvent.

### EXAMPLE 7—COMPARATIVE EXAMPLE (OUTSIDE THE INVENTION)

Solutions of stearic acid chloride at 0.05%, 0.1% and 0.5% in petroleum ether 100/150 are prepared. Tissues are impregnated with these various solutions and also a control produced with pure solvent, the majority of the solvent is left to evaporate and then the tissues are placed in the oven for 2 minutes at 150° C. The door of the oven is then opened and, in all cases, the formation of a fog of condensation is observed. This fog is greater in the case of the solution at 0.5% and smaller in the case of the solvent alone. These results indicate that the petroleum ether 100/150 remains trapped in the fibres of the paper material when it is alone and that it is associated with the reactant when the latter is in excess. It is observed that it is necessary to continue the heating in the oven for a further 2 additional minutes in order to no longer observe the presence of the fog of condensation on opening the door.

The contact angle values of the various samples are determined and it is observed that the values obtained for 0.05% and 0.1% are 100° and 120° respectively whilst the values obtained for 0.5% are of the order of 150°. The experiment is done again with revealing tissues. A high hydrophobicity is observed for 0.5% but a significant hydrophobicity is also observed for 0.05% and 0.1%. These results indicate that the presence of residual solvent disrupts the correct implementation of the chromatogenic acylation reaction.

### EXAMPLE 8—ACYLATION TREATMENT ACCORDING TO THE INVENTION—BRUSHING METHOD

A “Diall” varnish roller with dimensions of 4×10 cm having filiform elements made of mohair wool, previously loaded with 1 ml of stearic acid chloride is attached to a rod which is then mounted on an adjustable variable speed electric drill. The rotating varnish roller is then moved closer to a disposable tissue to be treated so that the free ends of the filiform elements of the varnish roller brush the surface of the tissue. This is carried out so as not to deteriorate the structure of the tissue. The procedure of example 1 is then followed. Fatty acid chloride is deposited successively on the tissues of a series of disposable tissues until optimal hydrophobicity properties are obtained on the face on which the fatty acid chloride was deposited and a low hydrophobicity is obtained on the face opposite the deposition face. The tissue is weighed before and after deposition. Values of 1 mg of acid chloride per face are obtained, which are equivalent to those deposited by roller according to the method described in example 1. The filiform elements of the velvet have a degree of freedom which enables them to slide over the surface of the tissue and are suitable for efficiently transferring the fatty acid chloride onto the surface of the tissue.

### EXAMPLE 9—RELOADING OF THE ROLLER

The varnish rollers initially loaded with 1 mL of fatty acid chloride (as described in example 1) and used for the coating of sheets of paper material end up running out after the deposition of fatty acid chloride on a large number of sheets of paper material. They are reloaded by depositing 50 μl of fatty acid chloride at the bottom of the deposition container and by making the varnish roller absorb this amount of fatty acid chloride. These reloaded varnish rollers behave like new rollers loaded with 1 mL of reactant. These results are in agreement with the measurements of amounts of deposit of reactant carried out by direct weighing.

### EXAMPLE 10—DEEP/SURFACE DISTRIBUTION

Stearic acid chloride is applied to a disposable tissue composed of a superposition of four associated layers. After application of stearic acid chloride to one of the main faces (layer no. 1) of the tissue by one or other of the methods of examples 1 or 8 above, the various layers are separated and are placed in the oven. It is observed that the first layer (layer no. 1) is highly hydrophobic but the results are different depending on the deposition methods. By application according to the method described in example 1, it is observed that the layer no. 2 is hydrophobic and also the layer no. 3, but to a lesser extent. By application according to the method described in example 8, only the layer no. 1 is highly hydrophobic. These results indicate that the reactant is capable of penetrating to a greater or lesser extent into the thickness of the paper as a function of the deposition method. The method described in example 1 enables the fatty acid chloride to penetrate deeper, whereas the method described in example 8 enables a superficially limited deposition.

### EXAMPLE 11—TRANSFER OF REACTANT

A sheet of kitchen roll is chosen as solid material, which has been loaded according to the method described in example 8 above using a varnish roller reloaded with fatty acid chloride so as to deposit fatty acid chloride mainly on the surface of the sheet of kitchen roll. Virgin rollers are now used and they are applied to this sheet according to one of the methods described in examples 1 and 8. Next, these rollers are used to coat virgin sheets. After coating, these sheets are placed in the oven for 1 minute at 150° C. and tested for their hydrophobicity. It is observed that the sheets coated according to the method described in example 8 are more hydrophobic than those coated according to the method described in example 1. The method described in example 8 is more effective than the method described in example 1 for recovering reactant at the surface of the first coated sheet and transferring it to another sheet. These results indicate that the two deposition methods are not equivalent. The method described in example 1 tends to make the reactant penetrate deeply into the thickness of the paper sheets whilst the method described in example 8 enables a more superficial spreading of the fatty acid chloride.

### EXAMPLE 12—DISTRIBUTION TEMPERATURE

A varnish roller is loaded with fatty acid chloride in an optimal manner in accordance with example 1. Sheets continue to be coated with this roller according to the method described in example 1 or according to the method described in example 8 without reloading it but by placing the sheets at a temperature of 60° C. It is observed that the hydrophobicity of the sheets coated at 60° C. is better than that carried out at ambient temperature. These results indicate that the reactant transfer efficiency is better at higher temperature.

### EXAMPLE 13—HOT DEPOSITION

A varnish roller is loaded with fatty acid chloride in an optimal manner in accordance with example 1. A tissue is placed in the oven at 160° C. so that it reaches its thermal equilibrium. Next the door of the oven is opened and the fatty acid chloride is deposited with the varnish roller directly on the hot tissue in the oven. No fog of condensation is observed during the deposition. The tissue is then removed from the oven and tested for its hydrophobicity. This is excellent with a distinct water repellency. This experiment shows that it is possible to carry out the deposition of the fatty acid chloride at high temperature corresponding to chromatogenic reaction conditions. The deposition and the reaction are virtually simultaneous. The additional advantage of this high-temperature deposition is that it makes it possible to eliminate at least one portion of the water contained in the paper, which could lead to a partial hydrolysis of the fatty acid chloride, and to carry out the acylation under substantially anhydrous conditions.

### EXAMPLE 14—BEHENIC ACID CHLORIDE

Palmitic acid chloride and behenic acid chloride are used as reactant. Good results are obtained in both cases. The hydrophobicity conferred by the palmitic acid is lower, whereas that conferred by the behenic acid is excellent.

### EXAMPLE 15—OLEOPHILIC VELVET ROLLER AND OLEOPHOBIC VELVET ROLLER

A comparative test of the distribution of a fatty acid chloride on a paper material is carried out:
using a varnish roller formed of an oleophilic velvet according to the invention, and;
using a varnish roller formed of an oleophobic velvet according to the invention in which the filiform elements are coated with Teflon®.

The varnish roller having an oleophobic velvet necessitates eliminating, prior to the deposition, an excess of fatty acid chloride distributed non-uniformly on the surface of the varnish roller, but the deposition of residual fatty acid chloride gives excellent results in terms of hydrophobicity.

### EXAMPLE 16—POLYVINYL ALCOHOL (PVA)

100 mg/m² of stearic acid chloride is applied with a varnish roller to a sheet of paper coated with 10 g of PVA 2899 having an average molecular weight of 145 000. This sheet is placed in an oven at 150°. After one minute, the door is opened and no formation of fog of condensation is observed, which indicates that there is no significant excess of reactant. The sheet is then tested for its hydrophobicity and it proves to be perfectly water repellent.

### EXAMPLE 17—COMPARATIVE TEST—FOAM ROLLER (OUTSIDE THE INVENTION)

A foam roller is loaded with 1 ml of fatty acid chloride. The loading of the foam roller is homogenized by rolling. The roller is applied to a sheet of kitchen roll. After passing through the oven at 150°, the hydrophobicity of the sheet of kitchen roll is analysed. It is observed that the hydrophobicity is irregular. The sheet of kitchen roll has hydrophobic zones and non-hydrophobic zones. The foam roller does not allow a distribution of the fatty acid chloride on the sheet of kitchen roll such that it enables an impermeabilization of the sheet of kitchen roll.

There may be numerous variants and applications of the invention other than those described above. In particular, it goes without saying that, unless indicated otherwise, the different structural and functional characteristics of each of the embodiments described above should not be considered as being combined and/or closely and/or inextricably linked with one another, but, by contrast, as being simple juxtapositions. Moreover, the structural and/or functional characteristics of the different embodiments described above may be subject in full or in part to any other juxtaposition or any other combination.

1. A process for acylation of a solid material bearing hydroxyls (—OH), referred to as reactogenic hydroxyls, which are accessible and capable of reacting with a fatty acid chloride in the gaseous state, said process comprising the steps of:
at least one fatty acid chloride is distributed at least on the surface of said solid material using a distributor device having an application surface suitable for depositing said at least one fatty acid chloride at least on the surface of said solid material from said application surface;
said at least one fatty acid chloride distributed at least on the surface of said solid material is heated, at a temperature, referred to as acylation temperature, below the vaporization temperature of said at least one fatty acid chloride, so as to enable an acylation of said solid material by reaction of at least one fatty acid chloride in the gaseous state over at least one of said reactogenic hydroxyls of said solid material, and;
a stream of a gaseous composition is directed over said solid material at said acylation temperature, so as to entrain at least one portion of gaseous hydrochloric acid formed by the acylation reaction;
wherein the application surface of the distributor device is a velvet provided with velvet filiform elements that are non-reactive with respect to said at least one fatty acid chloride and are suitable for:
taking up said at least one fatty acid chloride by contact with said at least one fatty acid chloride, and;
releasing said at least one fatty acid chloride by bringing the filiform elements of the velvet into contact with said solid material;
the distribution step being carried out so as to distribute over said solid material an amount of said at least one fatty acid chloride of between 20 mg/m² and 1 g/m² surface area of said solid material.

2. The process according to claim 1, wherein said at least one fatty acid chloride is distributed at least on the surface of said solid material by brushing of free longitudinal ends of the velvet filiform elements of the application surface over the surface of said solid material.

3. The process according to claim 1, wherein the distributor device comprises at least one applicator roller having said application surface, said at least one applicator roller being rotatably mounted with respect to said solid material and in that said at least one fatty acid chloride is distributed by rotating said at least one applicator roller, said application surface being in contact with said solid material.

4. The process according to claim 3, wherein the solid material being in the form of a strip moved in a run direction parallel to the largest dimension of the strip, between a reel upstream of said strip and a take-up roll downstream of a strip of acylated solid material;
said at least one fatty acid chloride is deposited continuously on at least one free surface of said moving solid material, and;
said at least one fatty acid chloride deposited on the surface of said solid material is distributed at least on the surface of said solid material by means of the distributor device, and;
said solid material is heated so that said at least one fatty acid chloride distributed at least on the surface of said solid material reaches said acylation temperature on said solid material, and;
the stream of gaseous composition is directed over said solid material at said acylation temperature, whereby said solid material is acylated.

5. The process according to claim 4, wherein said at least one acid chloride is deposited continuously on at least one of the free main surfaces of said solid material by means of a printing device.

6. The process according to claim 5, wherein the printing device is chosen from the group formed of flexographic printing devices and heliographic printing devices.

7. The process according to claim 3, wherein said solid material being in the form of a strip moved in a run direction parallel to the largest dimension of the strip, between a reel upstream of said strip and a take-up roll downstream of a strip of acylated solid material;
said at least one fatty acid chloride is deposited continuously on the applicator roller rotated in contact with said solid material, whereby said at least one fatty acid chloride is distributed at least on the surface of said solid material from the rotated applicator roller, and;
said solid material is heated so that said at least one fatty acid chloride distributed at least on the surface of said solid material reaches said acylation temperature, and;
the stream of gaseous composition is directed over the paper material at said acylation temperature.

8. The process according to claim 7, wherein said at least one fatty acid chloride is deposited on the rotated applicator roller, by contact of said rotated applicator roller with an anilox roller of a printing device loaded with said at least one fatty acid chloride.

9. The process according to one of claim 1, wherein the velvet filiform elements are formed of at least one material chosen from the group formed of keratin fibres, aramid fibres, polyester fibres, polyamide fibres, acrylic fibres, fluorinated fibres, fibres provided with a fluorinated coating, microfibres, woven microfibres, super-microfibres and ultra-microfibres.

10. The process according to one of claim 1, wherein said at least one acid chloride is deposited on the surface of said solid material by means of a distributor device having an application surface previously loaded with said at least one fatty acid chloride.

11. The process according to claim 10, wherein said solid material is a disposable tissue.

12. The process according to one of claim 1, wherein the velvet filiform elements have a length between 1 mm and 10 mm.

13. The process according to claim 4, wherein the rotatable applicator roller is rotated with an angular speed of rotation chosen so that the free ends of the velvet filiform elements are rotated with a linear velocity having a value different from the value of the run speed of said solid material.

14. The process according to claim 4, wherein the rotatable applicator roller is rotated in a direction of rotation chosen so that the free ends of the velvet filiform elements are moved countercurrent to the movement of the strip of said solid material.

15. The process according to claim 4, wherein the rotatable applicator roller is rotated in a direction of rotation chosen so that the free ends of the velvet filiform elements are moved concurrent to the movement of said solid material.

16. The process according to claim 1, wherein the velvet filiform elements have a flexibility chosen so as not to damage said solid material by contact with said solid material.

17. The process according to claim 1, characterized in that said solid material has an outer surface layer formed of polyvinyl alcohol.

18. The process according to claim 1, a composition, referred to as acylation composition, comprising said at least one fatty acid chloride and acetyl chloride is distributed at least on the surface of said solid material.
